(19) United States
(12) Patent Application Publication
(10) Pub. No.: US 2019/0085612 A1
(43) Pub. Date: Mar. 21, 2019

(54) A NOISE DAMPENING DEVICE

(71) Applicant: Superlift Garage Door Openers Ltd, Kwun Tong (HK)

(72) Inventor: Peter Ladics, Kwun Tong (HK)

(73) Assignee: Superlift Garage Door Openers Ltd, Kwun Tong (HK)

(21) Appl. No.: 16/085,173

(22) PCT Filed: Mar. 14, 2017
(86) PCT No.: PCT/AU2017/000064

§ 371 Date: Sep. 14, 2018

(30) Foreign Application Priority Data
Mar. 14, 2016 (AU) 2016900943

(51) Int. Cl. E05F 15/684

(52) U.S. Cl. CPC E05F 15/684; E05Y 2900/106; E05Y 2800/422; E05Y 2201/656

(57) ABSTRACT

The present invention relates to a noise dampening device for a power door or gate assembly including a chain loop adapted in use to run along and/or within a track or rail. The noise dampening device includes cushioning means attached to an internal surface of the track or rail. The cushioning means is configured to substantially follow and being in register with at least part of the chain loop.

### TECHNICAL FIELD

The present invention relates to a noise dampening device. More particularly, the present invention relates to a device suitable for use to dampen rattling noise generated by a drive chain during its operation being part of a powered door or gate assembly.

### BACKGROUND OF THE INVENTION

A typical known powered door assembly is disclosed in FIG. 1 of Australian patent application number 2008201482. Such a door assembly includes a sectional garage door with an articulated series of linked panels arranged to be movable between a closed vertical position and an open, overhead horizontal position. The door is designed to be driven by an electric motor by way of a door arm hingedly connected to the door. The door arm is driven by means of a drive sprocket engaging with a chain which moves a drive trolley along an overhead longitudinal metal track. The track is mounted to the wall above the garage door opening and an idler sprocket is mounted at the header end of the track. The drive trolley can therefore be moved in opposite directions to open and close the door.

As shown in FIGS. 1 and 1A of the published specification of AU2008201482, the chain described above, being supported by the drive and idle sprockets, is partially enclosed by a C-shaped metal track or channel. When in operation, the chain often sags from time to time, particularly during acceleration and deceleration. As a result, the chain has a tendency to impact on the floor of the longitudinal track as both the chain and the rail are made out of metal, a significant amount of banging or rattling noise and vibration is therefore generated when the metal to metal contact occurs. Such noise is a bit of a nuisance and the vibration would reduce the life-expectancy of the door driving system due to wear and tear resulting from the impact.

Various previous attempts have been made to minimise the occurrence of noise. For instance, the invention disclosed in AU2008201482 involves a plastic device adapted for attachment to selected links of the chain such that when attached, the device is fixed to and movable with the link and presents one or more surfaces to an environment surrounding the chain. The one or more surfaces is/are provided with dampening means to reduce noise associated with the chain contacting the surrounding environment. This device however has at least the following shortcomings:
1) installation of the multiple devices described above is labour intensive; and
2) a large number of devices is required to cover the entire length of the chain, which increases the cost.
Other attempts include using a toothed plastic drive belt in place of a metallic chain. Although the rattling noise may be reduced by this approach, the cost of such a belt is far more than that of a chain. Also, such a belt has a shortcoming that it tends to stretch and hence does not have the same long term durability of a chain.

It is an object of the present invention to provide a noise dampening device which may overcome or ameliorate the above shortcomings, or which will at least provide a useful alternative.

### SUMMARY OF THE INVENTION

According to one aspect of the present invention, there is provided a noise dampening device for a power door or gate assembly including a chain loop adapted in use to run along and/or within a track or rail, the noise dampening device including cushioning means attached to an internal surface of the track or rail, the cushioning means substantially following and being in register with at least part of the chain loop.

Preferably, the rail or track is a C-shaped channel or extrusion with a pair of returns. More preferably, each return includes a groove adapted to accommodate the cushioning means. Optionally, an upper portion of the cushioning means extends beyond the groove.

In a preferred embodiment, the noise dampening device includes an adhesive adapted to facilitate adhesion of the cushioning means onto the internal surface of the track or rail. The device may work with or without the adhesive if a hard-backed cushioning means is used. The internal surface may be the floor of each groove.

In a preferred embodiment, the chain loop including a plurality of connected links. Preferably, the chain is supported and driven by a sprocket. More preferably, the cushioning means is in the form of an elongate strip located below the chain covering the vast majority of its length. As such, the cushioning means prevents direct metal to metal contact of the links with the track or rail when the chain sags under gravity particularly during acceleration and deceleration. This results in a substantial reduction or prevention of noise and vibration.

The cushioning means is preferably adapted to dampen, absorb or counteract an impact of the chain on the internal surface of the metal track thereby reducing or preventing any rattling or banging noise when the chain sags resulting in the connected links hitting or landing on the cushioning means. The cushioning means may include any shock absorbing or resilient materials in the form of padding. Optionally, the padding is equipped with a hard backing. Conveniently, the hard backing includes adhesive on its bottom surface. Preferably, the shock absorbing or resilient materials may include at least one of the following: felt, foam, leather, soft rubber, nylon, silicon and a body of air. Optionally, the cushioning means includes a structure including a pile of bristle stemming from a hard backing. The hard backing may include an adhesive on its bottom surface so as to facilitate adhesion of the structure to the floor of the groove.

In an alternative embodiment, the power door or gate assembly includes a drive trolley being associated with the chain. Preferably, the drive trolley is adapted to be located such that a gap is provided between the drive trolley and the cushioning means. More preferably, the drive trolley includes a step adapted to escalate the drive trolley to a position where there is no contact between the drive trolley and the cushioning means when the power door or gate assembly is in operation.

According to another aspect of the present invention, there is provided a powered door or gate assembly including:

a rail or track;

a chain loop including a plurality of connected links, the chain loop being adapted in use to run along and/or within the rail or track; and

a noise dampening device including cushioning means attached to an internal surface of the track or rail;

wherein the cushioning means substantially follows, and is in register with, at least a part of the chain.

### BRIEF DESCRIPTION OF THE DRAWINGS

The invention may be better understood from the following non-limiting description of preferred embodiments, in which:

FIG. 1 is a perspective view of a track with a cushioning means in accordance with a preferred embodiment of the present invention;

FIG. 2 is a perspective view of the track and cushioning means of FIG. 2 in combination with a chain located above the cushioning means;

FIG. 3 is a perspective view of the cushioning means of FIG. 1 with a hard backing and an adhesive tape;

FIG. 4 is a cross-sectional view of the cushioning means of FIG. 3;

FIG. 5 is a perspective view of the track of FIG. 1 and a cushioning means in accordance with another preferred embodiment of the present invention;

FIG. 6 is a transparent perspective view illustrating the interior of the track including the cushioning means of FIG. 5; and

FIG. 7 is a perspective view illustrating the track with a cut out for the purpose of showing its interior and cushioning means of FIG. 1 in operation with a drive trolley.

### DETAILED DESCRIPTION OF THE DRAWINGS

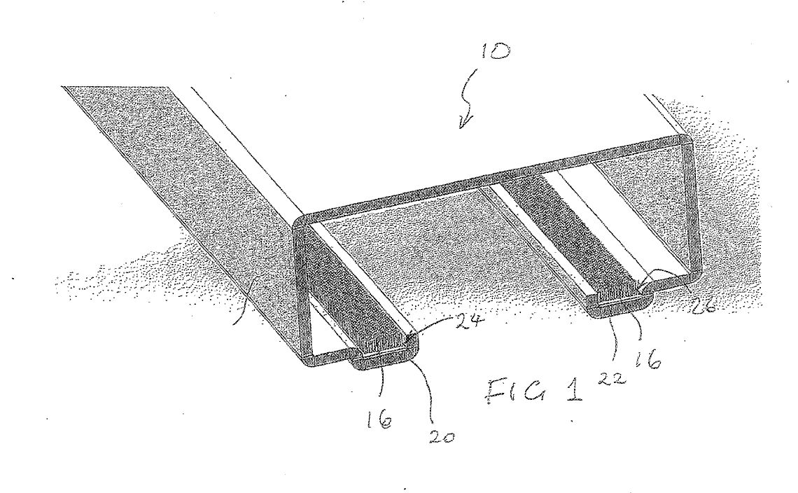

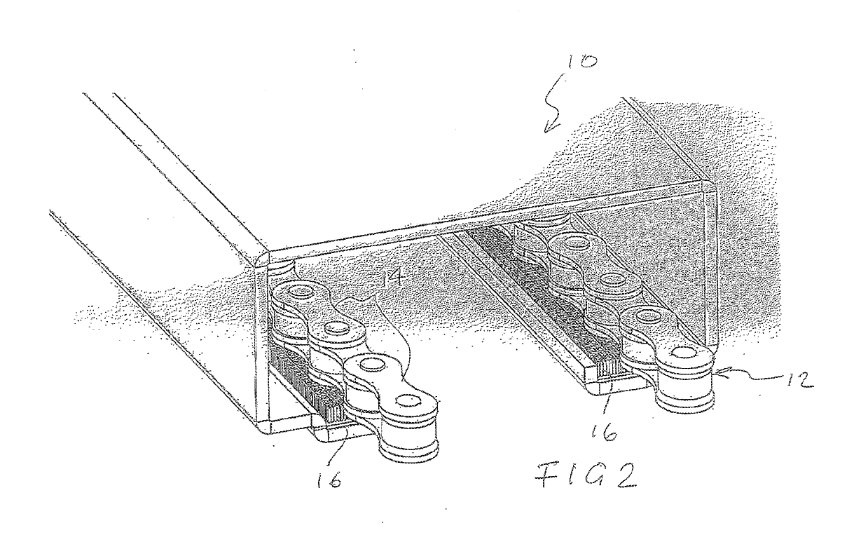

Referring to FIGS. 1 to 2, a metal track 10 is shown being part of a powered door or gate assembly (not shown). The door or gate assembly has a chain loop 12 which has a plurality of connected links 14. The chain loop 12 is configured in use to run along and within the metal track 10. The door or gate assembly also has a noise dampening device which includes cushioning means in the form of a pair of elongate cushioning strips 16 attached to an internal surface of the track 10. As best shown in FIG. 6, each of the elongate cushioning strips 16 substantially follows, and is in register with, the straight portion 18 of the chain.

Referring to FIGS. 1 and 2, the track 10 is a C-shaped metal channel with a pair of returns 20 & 22. Each of the returns 20 & 22 includes a groove 24, 26 for accommodating one cushioning strip 16.

Referring to FIG. 2, the connected links 14 of the chain loop 12 are supported and driven by drive and idle sprockets (not shown). Each cushioning strip 16 is located below the chain 12. The cushioning strips 16 cover the vast majority of the length of chain loop 12. The only portions of the chain loop 12 that are not covered are the ones that go around the drive and idle sprockets. As such, the cushioning strips 16 prevent direct contact of the links 14 with the metal track 10 when the chain 12 sags under gravity particularly during acceleration and deceleration. This results in a substantial reduction or prevention of rattling and/or banging noise and vibration caused by the impact of the links 14 on the surface of the C-shaped channel.

The cushioning strips 16 are provided to dampen, absorb or counteract the impact of the links 14 on the C-shaped channel. As such, the cushioning strips 16 may include any shock absorbing or resilient materials in the form of padding. Ideally, each cushioning strip 16 is equipped with a hard backing so as to facilitate placement of the cushioning strip into the groove 24, 26. The shock absorbing or resilient materials may include one of the following: felt, foam, leather, nylon, soft rubber, silicon and a body of air.

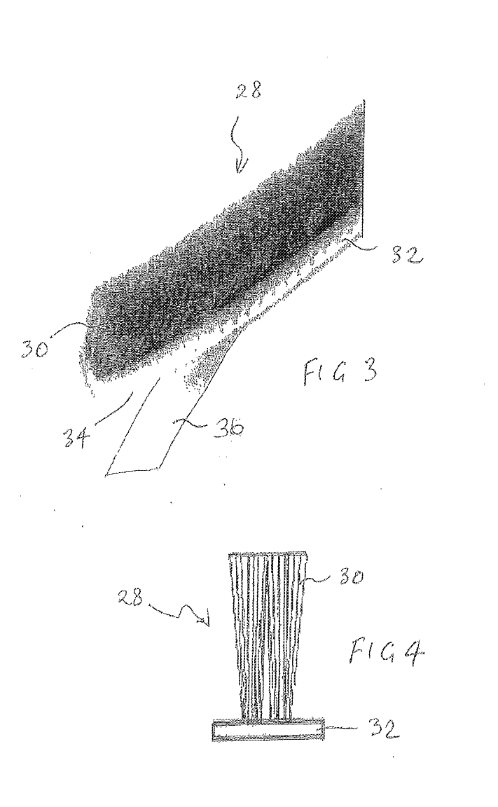

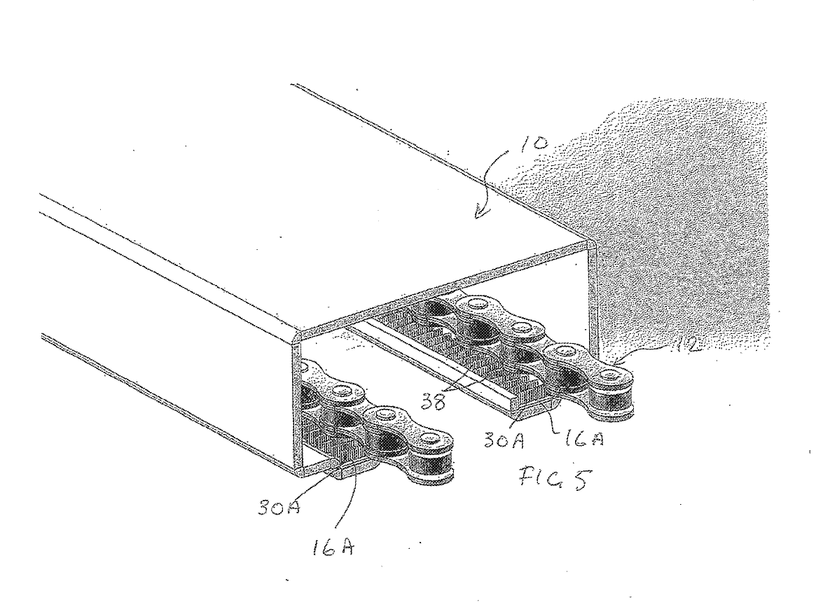

Referring to FIGS. 3 and 4, in the present exemplary embodiment, each of the cushioning strips 16 includes a structure 28 including a pile of bristle 30 stemming from a hard backing 32. The hard backing 32 has an adhesive 34 (see FIG. 3) on its bottom surface so as to facilitate adhesion of the structure 28 to the floor of the groove 24. The adhesive is covered by a thin layer of sealing tape 36 which is to be peeled off before installation of the cushioning strips 16.

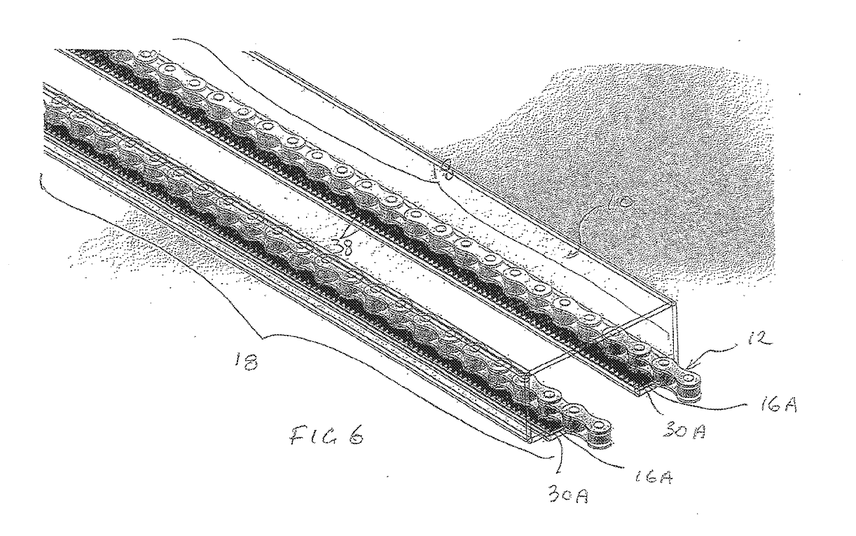

Turning to FIGS. 5 and 6, an alternate embodiment of the cushioning strips 16A is shown with bristles 30A arranged in spaced apart rows 38. This arrangement would serve the same purpose as preventing the chain loop 12 from contacting or impacting on the metallic track 20 thereby substantially reducing or eliminating the rattling and/or banging noise when the door assembly is in operation.

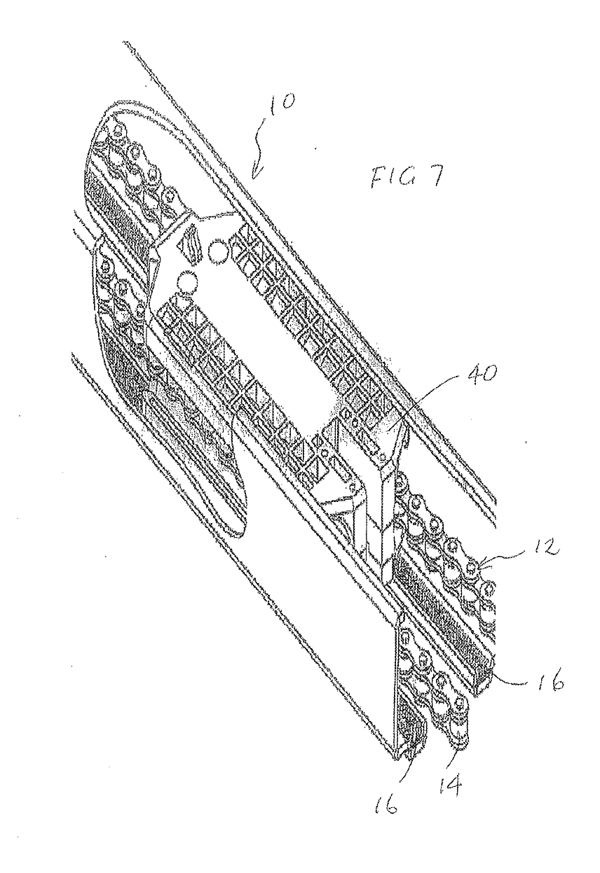

As shown in FIG. 7, the chain loop 12 is in operation moving a drive trolley 40 which is located in the middle of the track 10 along.

Now that a preferred embodiment of the present invention has been described in some detail, it will be apparent to a skilled person in the art that the noise dampening device of the present invention may offer at least the following advantages:
1. it enables substantial reduction or elimination of rattling and/or banging noise generated by contact between the links and the track when sagging of the chain occurs;
2. it is easy to install and apply;
3. it is economical to use requiring minimum raw materials and adaptation; and
4. it is easy to repair and replace if necessary.

Those skilled in the art will appreciate that the invention described herein is susceptible to variations and modifications other than those specifically described. For instance, the track may be replaced by a rail in another design of the door assembly. Optionally, the upper portion of the cushioning strips 16 may extend beyond the respective grooves 24 & 26 so as to further avoid any friction with other metallic surfaces of the returns 20 & 22. The noise dampening device may be applied to a gate assembly. As an alternate embodiment, the cushioning strips may be attached to the internal surface of the respective returns of the track if the returns come in plain without any groove. Furthermore, it is contemplated that the metal track or rail of the present invention may not include a groove. In such an embodiment, the drive trolley which is associated with the chain may be adapted to be located such that a gap is provided between the drive trolley and the cushioning means. One way to achieve this is for drive trolley to include a step such that it is escalated to a position where there is no contact between the drive trolley and the cushioning means when the power door or gate assembly is in operation. All such variations and modifications are to be considered within the scope and spirit of the present invention the nature of which is to be determined from the foregoing description.

1. A noise dampening device for a power door or gate assembly including a chain loop adapted in use to run along and/or within a track or rail, the noise dampening device including cushioning means attached to an internal surface of the track or rail, the cushioning means substantially following and being in register with at least part of the chain loop.

2. The noise dampening device of claim 1, wherein the rail or track is a C-shaped channel or extrusion with a pair of returns.

3. The noise dampening device of claim 2, wherein each return includes a groove adapted to accommodate the cushioning means.

4. The noise dampening device of claim 3, wherein an upper portion of the cushioning means extends beyond the groove.

5. The noise dampening device of claim 1, which includes an adhesive adapted to facilitate adhesion of the cushioning means onto the internal surface of the track or rail.

6. The noise dampening device of claim 1, wherein the chain loop includes a plurality of connected links.

7. The noise dampening device of claim 1, wherein the cushioning means is in the form of an elongate strip located below the chain covering the vast majority of its length.

8. The noise dampening device of claim 1, wherein the cushioning means includes any shock absorbing or resilient materials in the form of padding.

9. The noise dampening device of claim 8, wherein the padding is equipped with a hard backing.

10. The noise dampening device of claim 9, wherein the hard backing includes adhesive on its bottom surface.

11. The noise dampening device of claim 8, wherein the shock absorbing or resilient materials include at least one of the following: felt, foam, leather, soft rubber, nylon, silicon and a body of air.

12. The noise dampening device of claim 1, wherein the cushioning means includes a structure including a pile of bristle stemming from a hard backing.

13. The noise dampening device of claim 12, wherein the hard backing includes an adhesive on its bottom surface so as to facilitate adhesion of the structure to the floor of the groove.

14. The noise dampening device of claim 1, wherein the power door or gate assembly includes a drive trolley being associated with the chain.

15. The noise dampening device of claim 14, wherein the drive trolley is adapted to be located such that a gap is provided between the drive trolley and the cushioning means.

16. The noise dampening device of claim 15, wherein the drive trolley includes a step adapted to escalate the drive trolley to a position where there is no contact between the drive trolley and the cushioning means when the power door or gate assembly is in operation.

17. A powered door or gate assembly including:
a rail or track;
a chain loop including a plurality of connected links, the chain loop being adapted in use to run along and/or within the rail or track; and
a noise dampening device including cushioning means attached to an internal surface of the track or rail;
wherein the cushioning means substantially follows, and is in register with, at least a part of the chain.
